(19) United States
(12) Patent Application Publication
(10) Pub. No.: US 2006/0254709 A1
(43) Pub. Date: Nov. 16, 2006

(54) Flux guide induction heating method of curing adhesive to bond sheet pieces together

(76) Inventors: Marvin J. Bone JR., Arvada, CO (US); David O. Bone, Keenesburg, CO (US)

Correspondence Address: JOHN R LEY, LCC, 5299 DTC BLVD, SUITE 610, GREENWOOD VILLAGE, CO, 80111, US

(21) Appl. No.: 11/126,714

(22) Filed: May 11, 2005

(51) Int. Cl. B32B 37/00

(52) U.S. Cl. 156/272.2

(57) ABSTRACT

Alternating magnetic flux is directed through a high permeability flux guide to an area of overlapped electrically-conductive sheets between which a heat-curable adhesive material is positioned. Energy from the flux creates eddy currents in the overlapped sheets which dissipate power as heat, and the heat cures the adhesive to bond the sheets together. In addition to bonding, energy consumption is reduced and more uniformity in heating and curing of the adhesive material results from using the flux guide.

This invention relates to bonding sheet pieces, preferably sheet metal pieces, together with a heat-curable adhesive material. More particularly, this invention relates to a new and improved device and method which makes advantageous use of a high permeability magnetic flux guide to efficiently and effectively direct magnetic flux onto overlapped pieces of relatively thin sheet conductive metal for the purpose of quickly and uniformly curing heat-curable adhesive material located between the overlapped pieces and thereby bonding the overlapped pieces together. The present invention also applies to bonding non conductive materials, such as plastic sheets, by using a magnetic flux-responsive and heat generating adhesive material which is heated and cured by the application of magnetic flux delivered from the flux guide.

### BACKGROUND OF THE INVENTION

Many commercial products are manufactured by assembling pieces of relatively thin sheet metal. One common way of attaching pieces of sheet metal is by spot welding. Spot welding involves passing a relatively high magnitude pulse of welding current through the pieces of sheet metal while they are overlapped. The welding current density is sufficient to melt the metal together, thereby uniting the overlapped pieces at the spot where the welding current pulse was applied. Repeating the process at spaced apart locations along the overlapped metal pieces establishes sufficient structural strength to permanently hold the pieces in the desired orientation.

While spot welding is effective and has been used for a long time to unite sheets of metal, the equipment necessary to produce multiple spot welds quickly enough to mass manufacture commercial products is expensive, complicated to work with, and may require special protective and safety measures to assure that humans are not injured by contacting the equipment. Furthermore, the spots where the metal melted create irregularities in the surface of the metal sheets, and the spot welding itself may distort the metal sheets. When a smooth finish of the final commercial product is desired, additional surface treatment and finishing steps are required to smooth the surface. Spot welding will also destroy or disrupt surface coatings, depositions or compositions on the exterior of the metal sheets to protect them from corrosion, for example. Melting the metal at the welded spot eliminates the surface protection at that spot and provides an opportunity for corrosion or other chemical degradation to start and spread.

Another way of joining metal sheets is with a heat-curable adhesive bonding material. When cured, the adhesive bonding material adheres or joins the overlapped sheets of metal. The adhesive material adheres to protective coatings and depositions or compositions on the exterior of the metal sheets, and thereby does not degrade their resistance to corrosion. The adhesive material does not create surface blemishes or distortions. However, it is necessary to heat the typical adhesive materials to approximately 250-450° F. to cure them and create the bond.

To create a bond, the adhesive material is interspersed or sandwiched between the metal sheets and then the heat is applied after the metal sheets are oriented as desired. Heating the adhesive material to cure it therefore necessarily requires that the overlapping metal sheets also be heated in the area where the adhesive material is located and the bond is to be created.

Induction heating is prevalently used to cure adhesive material between conductive thin metal sheets. Previous induction heating techniques, represented by the prior art system 10 shown in FIG. 1, involve placing an electrical coil 12 adjacent to the metal sheets at the location where the adhesive is to be cured and the bond is to be created. High-frequency electrical induction current 14 is passed through the coil 12, and that induction current 14 induces a high-frequency magnetic flux field which interacts with overlapped sheet metal pieces 16 and 18. The magnetic flux induces eddy current flow in the overlapped conductive metal pieces. The eddy current flow interacts with the inherent resistance of the molecular and crystalline structures of the metal pieces 16 and 18 to dissipate power in the form of heat in the overlapped sheet metal. The amount of heat created in the overlapped metal pieces is directly related to the frequency of the magnetic field and the intensity of the magnetic field at the locations where it intersects the overlapped metal pieces.

The typical coil 12 used in induction heating is formed from an electrical conductor which takes the physical form of a single turn or winding. The electrical conductor which forms the coil 12 is bent into a U- or channel-shape so as to extend over both sides of an edge of the overlapped metal pieces 16 and 18. Alternatively, separate coils may be placed on opposite sides of the overlapped metal pieces, or other shapes of coils, such as L-shapes, may be employed (not shown in FIG. 1). The extent to which the magnetic field interacts with the overlapped metal pieces is established by the shape of the coil or coils which generate that magnetic field and by the proximity of the coil to the metal pieces. The shape and proximity of the coil also determine the extent to which heat is generated in the overlapped metal pieces, the efficiency of heat generation, the area in the overlapped metal pieces where heat is generated, and the uniformity of heat generation, among other things. In essence, the coil is principally responsible for the effectiveness of curing the adhesive material, because the effectiveness in curing the adhesive material is directly related to the heat applied to that material. For that reason, considerable previous effort in the field of curing bonding material by induction heating is focused on the configuration or shape of the coil.

Certain limitations restrict the shape of the coil 12. The coil is required to conduct enough induction current 14 to elevate the temperature of the metal pieces 16 and 18 to cure the adhesive 20. A typical coil 12 may be required to conduct in the neighborhood of 750 amps. Such a high induction current causes the coil itself to heat because of the conduction of the high current through the coil. The amount of heat produced in the coil itself from conducting the high induction current 14 is sufficient to melt the coil 12 unless the coil is cooled. It is for this reason that the electrical conductor of the coil 12 is formed from an electrically conductive tubing 22. The tubing 22 defines a central passageway 24 for carrying a liquid or gas coolant through the coil to remove the heat caused by the conducting the induction current 14, while the wall of the tubing 22 electrically conducts the induction current 14.

These constraints introduce limitations on the size of the coil. Size of the tubing 22 must have adequate wall thickness to withstand the very high current densities resulting from conducting the induction current 14 through the coil 12. The size of the interior passageway 24 must be large enough to carry enough coolant at a sufficient flow rate to remove the induction current-induced heat, prevent destruction of the coil and to maintain a safe operating temperature. Making the coil from tubing of this size is complicated because of the number of angles necessary to shape the coil while maintaining good electrical and coolant conductivity through the corners and angles of the different parts of the coil. As a result of these practical considerations, the coil must have a minimum size and the number of turns of the coil is limited, usually to one turn or possibly to two turns at most. Consequently, the coil occupies a significant amount of space. The size requirements limit the use of the coil to bonding metal pieces at locations which are readily accessible.

The requirements and limitations of the typical induction heating coil also lead to further complications and disadvantages for the entire coil-type induction heating system 10. A separate cooling system 26 is required to circulate coolant 28 through the coil 12 and to dissipate or exchange the heat generated by conducting the induction current 14 through the coil. The cooling system 26 as well as the coolant 28 must be electrically insulated from the coil 12 to prevent short-circuiting the induction current 14 away from the coil. In addition to these technical complexities, the separate cooling system 26 must be maintained in proper operating condition. The separate cooling system 26 increases the procurement cost of the coil-type induction heating system 10, as well as its operating cost since energy is consumed in operating the cooling system. Additional floor space in the manufacturing facility is consumed by the cooling system.

In addition to the separate cooling system, supplying the very high amperage, high-frequency induction current 14 to the coil 12 is also complicated. The typical electrical power 30 for the coil-type induction heating system 10 operates from 480 volt, three-phase, 60 cycle AC commercial power. It is necessary to distribute this type of electrical power throughout the manufacturing facility to the locations where each coil-type induction heating system 10 is used. High voltage electrical power 30 is required to deliver enough electrical power to satisfy the requirement for a very high induction current 14 to be supplied to the coil 12. A rectifier 32 converts the 480 volt, three-phase, 60 cycle AC commercial power 30 into lower voltage DC power. An inverter 34 generates an alternating waveform having the high-frequency at which the magnetic flux will be produced by the coil 12. Because the typical inverter 34 is not capable of generating the very high induction current 14 necessary to conduct to the coil, the high frequency waveform from the inverter is an intermediate waveform 36 that must be applied to an intermediate conversion transformer 38. The intermediate conversion transformer converts the intermediate waveform 36 into the very high induction current 14 that is then conducted to the coil. The induction current 14 conducted to the coil has the same high frequency as the inverter 34 establishes for the intermediate waveform 36.

The coil-type induction heating system therefore requires three electrical energy conversion steps: a first conversion from 480 volt, three-phase 60 cycle AC commercial power 30 to DC power; a second conversion from DC power to the high-frequency intermediate waveform 36; and a third conversion from the intermediate waveform 36 into the very high induction current 14 applied to the coil 12. Each of these three conversions involves energy losses, because energy losses are simply inherent in the electrical equipment which performs these conversions. As a result, a significant amount of the energy delivered to the coil-type induction heating system 10 is consumed in these conversions before the induction current 14 is created and supplied to the coil. The energy lost in these conversions is not available to create the magnetic flux from the coil and to heat the overlapped sheet pieces 16 and 18. Moreover, since a significant amount of the energy of the induction current 14 delivered to the coil 12 is consumed in heating the coil itself, that energy is also lost and is not available to heat the overlapped metal pieces.

Further still, a significant amount of the magnetic flux generated by the coil 10 is lost or leaked into the air surrounding the coil without interacting with the overlapped metal sheets. The energy used in generating the flux which leaks or escapes without interacting with the workpiece is also lost. The leakage flux results from using air as the medium for conducting the flux generated by the coil to the overlapped sheet metal. Air has a very limited capability of confining and directing magnetic flux, and for that reason, much of the generated flux leaks away from the metal pieces 16 and 18. The pattern of magnetic flux which reaches the overlapped sheet metal is determined primarily by shape and configuration of the coil itself. The ability of a medium to confine and direct magnetic flux is referred to as its permeability. Air has a permeability of 1.0, which is the lowest permeability of any material that directs magnetic flux. Flux concentrators have been positioned on or around the coil to attempt to direct the flux and reduce the leakage, but such flux concentrators are only partially effective. The typical permeability of a flux concentrator used with a typical single turn coil 12 is in the neighborhood of about 20. Flux concentrators are capable of interacting with only a small amount of the flux generated by the single turn coil, because much of that flux leaks into the air despite the use of flux concentrators. It is necessary to locate the coil as close as possible to the overlapped sheet metal, so the opportunity to locate the flux concentrators is limited. As a consequence of the leakage flux, only a reduced portion of the magnetic flux actually generated by the coil is directed onto the overlapped sheet metal and is therefore available to generate the heat necessary to cure the adhesive and create the bond.

All of these losses make coil-type induction heating systems inefficient. Only a small fraction of the energy supplied to a coil-type induction heating system is actually converted into the heat which cures the adhesive. For example, in the neighborhood of only 20 percent of the input energy delivered to a typical coil-type induction heating system is actually applied to the overlapped sheet metal to cure the adhesive. The lost energy is an added cost for operating coil-type induction heating systems. Moreover, because of the conversion losses, the rectifier 32, inverter 34 and intermediate transformer 38 must have greater capacities to supply the additional electrical power which will ultimately be lost. The requirement for greater capacity of these electrical components increases the acquisition cost of coil-type induction heating systems. In some cases, the greater capacity of these electrical components results in greater physical size of the overall coil-type induction heating system. The greater physical size can consume additional valuable floor space in the manufacturing facility which could otherwise be used for productive purposes.

Lastly, despite all the additional features and requirements necessary for a coil-type induction heating system, the coil can have a limiting effect on the strength and integrity of the bond. The strength and integrity of the bond depends on the extent to which the adhesive material is thoroughly and uniformly cured. The cure characteristics of the adhesive are directly related to the uniformity in temperature and uniformity of heat distribution within the overlapped sheet metal. The characteristics of the magnetic flux created by the coil 10 and the interaction of that magnetic flux with the pieces 16 and 18 is directly responsible for the uniformity and heat distribution within the overlapped sheet metal.

A single turn coil 12, or low turn coil, is essentially incapable of producing uniform magnetic flux over the entire area of the overlapping metal pieces 16 and 18 covered by the coil. Each bend and corner of the coil destroys any uniformity of the magnetic flux at those locations because of field discontinuities and disturbances created by changes in the physical conductor which carries the current that creates the magnetic field. Gaps between adjacent segments of the coil also introduce nonuniformities. Consequently, many coils employ relatively lengthy straight parts in an attempt to induce more uniformity in the magnetic flux through the midpoint of the relatively lengthy straight parts, while tolerating the inevitable nonuniformities at the ends and corner locations where the coil shape changes. The nonuniform flux creates nonuniform heat distribution. The nonuniform heat distribution introduces variability into the cure quality of the adhesive material. Less curing will occur in those areas which receive less heat, and those less-cured areas will have less bond strength and integrity compared to those areas which have received more heat. Furthermore, the adhesive material must not be overheated. Overheating the adhesive material can destroy its adhesive qualities and can introduce thermally-induced distortions into the sheet metal.

### SUMMARY OF THE INVENTION

This invention avoids the use of coils to inductively heat overlapped sheet metal to cure adhesive material between the sheet metal. By avoiding the use of coils, very significant increases in efficiency are achieved. For example, the present invention may consume one-fourth or less of the power required to operate a typical coil-type induction heating system. The size and capacity of the electrical components may be reduced. No separate cooling system is required. The physical size of the device of the present invention is reduced, so that valuable floor space in a manufacturing facility is available for other and additional uses. A more conventional low-voltage electrical power source is sufficient to supply power for the present invention. Magnetic flux may be applied more precisely and uniformly to the overlapped sheet metal, to develop a more uniform and better regulated temperature throughout the entire area of adhesive that is to be cured, which results in better curing and more integrally-consistent bond strength. These and other beneficial aspects are achieved in different forms of the invention.

The invention involves a method of curing a heat-curable adhesive material positioned between overlapping sheets of electrically-conductive material to bond the sheets together. The method involves directing alternating magnetic flux through a high permeability flux guide to an area of the overlapped sheets between which adhesive material is positioned, and flowing the magnetic flux substantially uniformly through the overlapped sheets at the area for a sufficient time to heat the sheets and cure the adhesive material to bond the sheets together.

The invention also involves a method of increasing uniformity in heating a heat-curable adhesive material positioned between overlapping sheets of electrically conductive material. An alternating magnetic flux is directed through a flux guide to an area of the overlapped sheets between which adhesive material is positioned. A flux guide is used which has a closed geometric configuration except at a gap defined by faces which extend across the flux guide. The overlapped sheets are inserted into the gap between the faces, and the flux flows substantially uniformly between the faces and through the overlapped sheets adjacent to the faces for a sufficient time to heat the sheets and the adhesive material substantially uniformly over the area of the sheets adjacent to the faces.

The invention further involves a method of reducing energy consumption when spot bonding overlapped sheets of electrically-conductive material with heat-curable adhesive material positioned between the overlapped sheets. An alternating magnetic flux is created in a high permeability flux guide by conducting an alternating drive current through a multi-turn winding positioned around a flux guide. The flux guide has a closed geometric configuration except at a gap defined by faces extending across the flux guide at the gap. Substantially all of the magnetic flux created by the drive current conducted through the winding is conducted through the flux guide to the gap. Commercial AC power is converted into DC power, and the DC power is converted directly into the alternating drive current conducted through the multi-turn winding. Substantially all of the flux at the gap flows through the overlapped sheets inserted into the gap for a sufficient time to dissipate energy from the magnetic flux as heat in the sheets and cure the adhesive material to bond the sheets together. Preferably, the overlapped sheets are heated substantially only at the areas adjacent to the faces to a temperature sufficient to cure the adhesive material.

Preferable features associated with these different aspects of the invention include some or all of the following features. The alternating drive current is conducted through a multi-turn winding positioned around the flux guide to create the flux. The flux guide has a closed geometric configuration except at the gap which extends across the flux guide. The flux flows through the gap with substantial uniformity or substantially uniform flux density. The faces at the gap are spaced apart from one another across the gap to permit insertion of the overlapped sheets in the gap while minimizing air spaces between the faces. Both faces may contact surfaces of the overlapped sheets in the gap to eliminate air spaces between the faces and the overlapped sheets. At least one of the faces may be formed on a movable segment of the flux guide, and that movable segment may be moved to contact its face with one surface of the overlapped sheets in the gap, or both faces contact the surfaces of the overlapped sheets in the gap. The flux guide segment may be moved to facilitate insertion and withdrawal the overlapped sheets at the gap. DC power is directly converted into the alternating drive current applied to the multi-turn winding. The amount of alternating drive current may be regulated to control the flux within the gap. The flux guide isolates the overlapped sheets from the AC power, the DC power and the alternating drive current with the flux guide. The number of turns of the winding around the flux guide may be varied to adjust the impedance into which the drive current is delivered at different operating frequencies to obtain power-transfer-enhancing impedance matching and to accommodate differing characteristics of the overlapped sheets and adhesive material. The uniform flux and flux density cures the adhesive material uniformly and substantially only at the areas adjacent to the faces.

A more complete appreciation of the scope of the present invention and the manner in which it achieves the above-noted and other improvements and beneficial aspects can be obtained by reference to the following detailed description of presently preferred embodiments of the invention taken in connection with the accompanying drawings, which are briefly summarized below, and by reference to the appended claims.

### BRIEF DESCRIPTION OF THE DRAWINGS

FIG. 1 is a block and schematic diagram of a prior art coil-type induction heating system.

FIG. 2 is a block and schematic diagram of a flux guide induction heating device which is used in practicing the present invention.

FIG. 3 is an enlarged view of a portion of a flux guide shown in FIG. 2, illustrating a gap in the flux guide into which overlapping pieces of metal are inserted to be bonded.

FIG. 4 is an enlarged perspective view of an alternative form of the flux guide shown in FIG. 2.

FIG. 5 is an enlarged partial cross-sectional view of a hem-type overlapped configuration of metal pieces as an alternative to the type of overlapped metal pieces shown in FIGS. 2 and 3.

### DETAILED DESCRIPTION

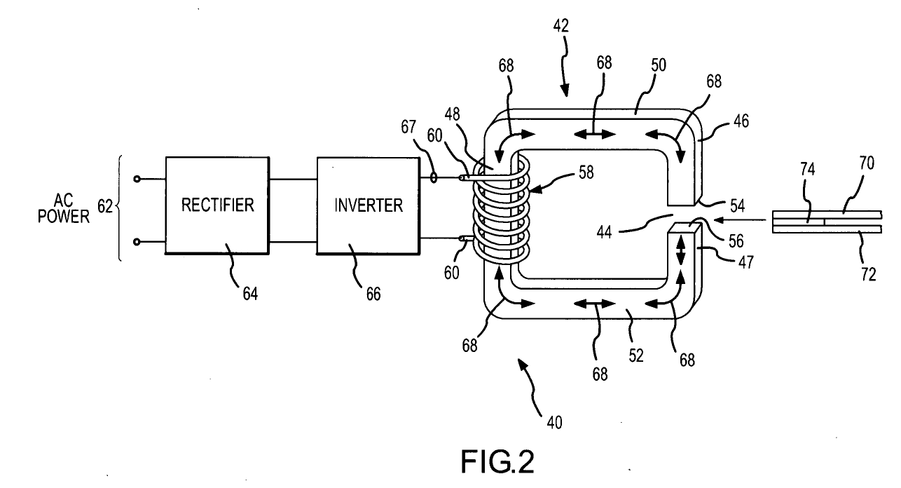

A flux guide induction heating device 40 which incorporates the present invention shown in FIG. 2. The device 40 includes a flux guide 42 which is formed of laminated or solid magnetic core material having a high permeability, such as power ferromagnetic material or one of a wide variety of known metallurgically-formulated, high permeability magnetic core materials typically used for cores in transformers. The flux guide 42 has a closed geometric configuration, except for a gap 44 which extends between segments 46 and 47 of the flux guide 42. Three other linked-together segments 48, 50 and 52 connect with the segments 46 and 47 to complete the closed geometric configuration of the flux guide 42. The gap 44 is defined between opposing faces 54 and 56 of the segments 46 and 47, respectively. The faces 54 and 56 extend completely across the segments 46 and 47 in a cross-sectional dimensional sense.

A winding 58 surrounds one or more of the segments 46, 47, 48, 50 or 52 of the flux guide. As shown in FIG. 2, the winding 58 surrounds the segment 48. The winding 58 is formed by winding an insulated electrical conductor 60 around the segment 48 in a predetermined plurality of turns.

Commercial alternating current (AC) power is supplied at 62 to the induction heating device 40 from conventional distribution mains. The AC power is rectified into direct current (DC) power by a conventional rectifier 64. The DC power from the rectifier 64 is supplied to a conventional inverter 66. The inverter 66 converts the DC power into a bipolar pulsating or alternating drive current 67 which has a predetermined high frequency established by the inverter 66. The high frequency drive current 67 from the inverter 66 is conducted through the conductor 60 of the winding 58.

The high frequency drive current flowing through the conductor 60 induces magnetic flux 68 in the flux guide 42. The amount of magnetic flux 68 induced in the flux guide 42 is directly related to the number of turns of the electrical conductor 60 around the segment 48 and the magnitude of the high frequency drive current 67 conducted through the conductor 60. The frequency of the magnetic flux 68 induced in the flux guide 42 is the same frequency as the bipolar pulsating or alternating drive current 67 created by the inverter 66. The direction that the flux 68 flows in the guide 42 changes twice with each cycle of the high frequency drive current 67.

The flux 68 readily flows within the segments 46, 47, 48, 50 and 52 of the flux guide 42 due to the high permeability of the material which forms the flux guide, compared to the significant lower permeability of the air which surrounds the flux guide. Greater benefits result from using a higher permeability material for the flux guide 42. The best benefits of the present invention result from a flux guide permeability of greater than approximately 500, and preferably at least 2000. However, significant benefits are available from a flux guide having permeability as low as approximately 100. The high permeability of the flux guide 42 results in the vast majority of the flux generated by the winding 58 being confined within the flux guide without leakage, except at the gap 44. In addition to its permeability, the flux guide 42 should be constructed from material which does not saturate magnetically at the level of the magnetic flux 68 created by the drive current 67 conducted through the winding 58. Avoiding magnetic saturation results in maximum power conversion from the energy of the drive current 67 into the energy of the magnetic flux 68. The material from which the flux guide is made should also exhibit adequate frequency responsive characteristics to avoid significant attenuation at the frequency of the bipolar pulsating or alternating drive current 67.

The amount of flux that flows through the gap 44 depends upon the reluctance of the medium which occupies the gap 44. If air is the medium in the gap 44, the amount of flux flowing through the gap will be limited by the relatively high reluctance of the air. Some of the flux will also leak from the gap 44 into the surrounding air. If an object with a higher permeability than air occupies the gap 44, a greater amount of flux will flow through the gap because the higher permeability object reduces the overall reluctance within the gap.

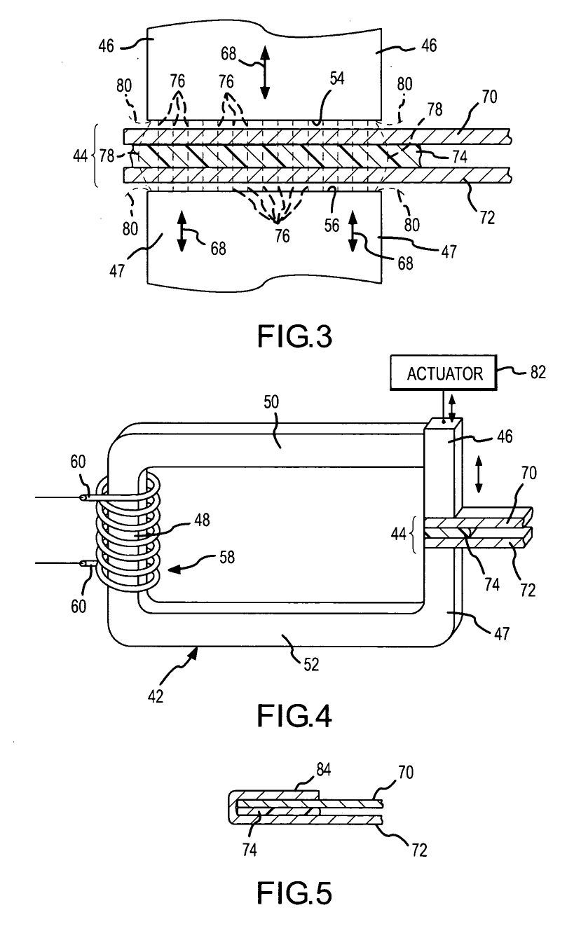

Overlapping electrically-conductive sheet metal pieces 70 and 72 are inserted into the gap 44 to induce heat in the sheet metal pieces 70 and 72 and cure a spot or zone of heat-curable adhesive material 74 which has been previously positioned between the sheet metal pieces 70 and 72, as shown in FIGS. 2 and 3. Alternating eddy currents are induced in the sheet metal pieces 70 and 72 with each reversal in direction of the flux 68. The eddy currents interact with the inherent resistance of the molecular and crystalline structures of the metal pieces 70 and 72 and dissipate electrical power in an amount related to the square of the magnitude of the induced eddy currents multiplied by the inherent resistance of the sheet metal pieces 70 and 72 (1²R). This electrical power is dissipated as heat in the metal pieces 70 and 72. The electrical power that is dissipated as heat in the pieces 70 and 72 is obtained from the energy of the flux 68 which flows through the metal pieces 70 and 72 when they are placed in the gap 44. The magnitude of the eddy currents induced in the metal pieces 70 and 72 increases with the amount of magnetic flux which interacts with those pieces. Larger eddy currents results in larger power dissipation which in turn increases the amount of heat induced in the metal pieces. The heating capacity is therefore related to the ability to provide magnetic flux 68 in the gap and couple that magnetic flux to the overlapping sheet metal pieces 70 and 72.

The object which occupies the gap 44 should have the capability of conducting electrical current in order to be heated by the eddy currents induced in that material. For example, copper and aluminum have a permeability of 1.0, as does air, but both copper and aluminum will be heated by the alternating magnetic flux flowing through the gap 44 because both metals are electrically conductive and therefore have the capability of conducting the eddy currents which dissipate the energy from the magnetic flux as heat. A material with a permeability greater than 1.0 which occupies the gap 44, such as iron or steel, contributes to the flow of flux through the flux guide 42 by reducing the reluctance through the gap 44, and the reduced reluctance of the gap causes the increased flux to heat the higher permeability material more quickly because of the increased eddy current flow through that material.

The magnetic flux 68, represented by the dashed lines 76 shown in FIG. 3, flows directly and uniformly between the faces 54 and 56 of the flux guide segments 46 and 47, and directly through the overlapping sheet metal pieces 70 and 72. A slight amount of deviation of the flux 68, represented by the dashed lines 78 shown in FIG. 3, occurs near the outside periphery of the gap 44. Because a space or clearance exists in the gap between the face 54 and the metal piece 70, and between the face 56 and the metal piece 72, a very small amount of the flux 68 leaks from the gap 44 without interacting with the sheet metal pieces 70 and 72. The flux leakage occurs primarily at the corners of the faces 54 and 56 and is represented by the dashed lines 80 shown in FIG. 3. However, the amount of flux which leaks from the gap 44 into the surrounding air without interacting with the metal pieces is extremely small compared to the flux that flows through and directly interacts with the metal pieces 70 and 72. Similarly, the amount of flux that deviates around the periphery of the gap 44 (shown at 78) compared to the flux that directly flows through the metal pieces 70 and 72 (shown at 76) is minimal. Consequently, the vast majority of the flux which flows through the gap 44 and the overlapped sheet metal pieces 70 and 72 is uniform throughout that area of the metal pieces 70 and 72 which adjoins the faces 54 and 56.

The amount and uniformity of the flux flowing through the overlapped metal pieces 70 and 72 can be further increased by contacting the faces 54 and 56 directly against the sheet metal pieces 70 and 72, respectively, as shown in FIG. 4. The flux guide segment 46 is movable in the vertical sense as shown in FIG. 4, as a result of connecting it to an actuator 82. The movable flux guide segment 46 magnetically couples with the flux guide segment 50, so that the substantial majority of the magnetic flux is directly coupled between the segments 46 and 50, despite the movable nature of the segment 46. The actuator 82 moves the segment 46 to increase the space between the faces 54 and 56 in the gap 44 to thereby facilitate inserting the overlapped sheet metal pieces 70 and 72 in the gap 44. Once the metal pieces 70 and 72 are within the gap 44, the actuator 82 moves the segment 46 toward the overlapped metal pieces until the face 54 contacts the outer surface of the metal piece 70 and the face 56 contacts the outer surface of the metal piece 72. In this situation, shown in FIG. 4, very little or no air gap exists between the faces 54 and 56 and the metal pieces 70 and 72.

The elimination of the air gap further reduces the reluctance of the gap between the faces 54 and 56 and results in greater flux flowing through the metal pieces 70 and 72. Leakage flux (80, FIG. 3) is substantially eliminated because there is no air gap from which the flux may leak. Flux deviation (78, FIG. 3) at the periphery of the gap is reduced because of the reduced reluctance resulting from substantially eliminating the air gap. Increasing the amount of flux flowing through the overlapped metal pieces 70 and 72, decreasing or eliminating the leakage flux and decreasing the flux deviation at the periphery of the gap all leads to a greater amount of more uniform heating throughout the area of the metal pieces 70 and 72 contacted by the faces 54 and 56.

A substantially uniform density of flux 68 is therefore established through the overlapping sheet metal pieces 70 and 72 within the gap 44, with either the fixed gap (FIG. 3) or adjustable gap (FIG. 4) embodiments of the flux guide 42. The substantially uniform flux density assures substantially uniform power dissipation and heating of the metal pieces 70 and 72. The resulting substantially uniform temperature uniformly cures the bonding material 74 between the pieces 70 and 72 over the areas which adjoin the faces 54 and 56, and thereby obtains better bond strength from the integrally and consistently cured adhesive material 74.

Although the sheet metal pieces 70 and 72 have been shown as overlapped at coextensive edges in FIG. 2-4, the sheet metal pieces 70 and 72 can also be overlapped in a hem-type configuration shown in FIG. 5. The hem-type overlap is created by folding a flap 84 of the metal piece 72 over around the end edge of the metal piece 70 and down on top of the upper surface of the metal piece 70. The adhesive material 74 remains located between the metal pieces 70 and 72. Adhesive material could also be placed between the metal piece 70 and the flap 84. The metal pieces 70 and 72 and the flap 84 are then heated with the flux guide 42 to cure the adhesive material 84.

The hem-type overlap shown in FIG. 5 is typically used for assembling body panels into automotive components. The adhesive material 74 is cured at spaced-apart spots along the periphery of the edge of the panels. Enough spots are cured to securely fasten the outer panel to an interior support panel and hold the two panels together in the final intended shape. Thereafter, the component is assembled into the remaining automobile body structure, and the entire body structure is coated with paint. The paint is dried by placing the entire automobile body structure into an heated oven. The temperature within the oven is sufficient to cure the remaining adhesive material between the spots that were cured by use of the flux guide 42, thereby more securely fastening the panels together. Induction heating of adhesive material to bond panels together is extensively used in other industries in addition to automobile manufacturing.

The flux guide induction heating device 40 can also be used to cure heat-curable adhesive material placed between sheet pieces which are not electrically conductive, provided that the composition of the adhesive material 74 generates heat when magnetic flux interacts with it. Including ferromagnetic or conductive particles in the adhesive material 74 may provide sufficient heat to cure this type of adhesive material.

The benefits of heat curing the adhesive material 74 with the flux guide 42 are numerous and substantial.

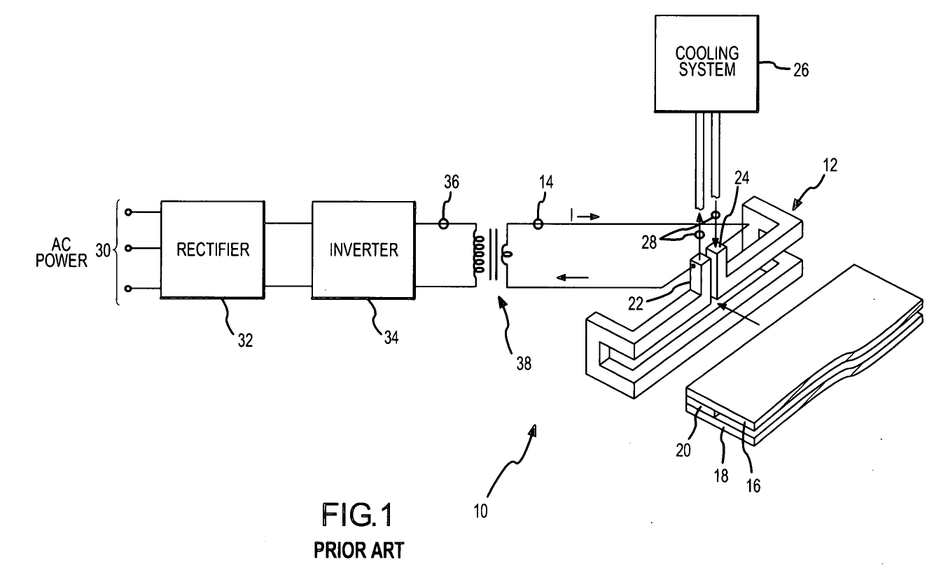

The high permeability flux guide 42 conducts substantially all of the flux 68 induced by the winding 58 to the gap 44 and through the overlapped sheet metal pieces 70 and 72. Very little of the flux induced by the winding 58 in the flux guide 42 is lost to leakage, compared to the substantial amount of flux that is lost to the air when using the prior art single turn coil 12 (FIG. 1). Consequently, the flux guide 42 is considerably more efficient in delivering the flux to heat the metal pieces 70 and 72.

The greater availability of flux 68, and the relative ease of inducing flux in the flux guide 42 by increasing the number of turns of the conductor 60 in the winding 58, offers the capability of heating the metal pieces 70 and 72 at an increased rate to diminish the amount of time necessary to obtain the bond. The amount of time required for curing the adhesive material 74 is diminished by more quickly elevating the temperature of the metal pieces. More quickly bonding the overlapping sheet metal pieces 70 and 72 offers the commercial benefit of reducing the time and expense of manufacturing each commercial product.

The area in the metal pieces 70 and 72 where the heat is induced is directly between the faces 54 and 56, and it is in this area that the adhesive material 74 is cured. Precision in the location and the degree to which the adhesive material is cured is obtained by directing the flux uniformly through the overlapping sheet metal pieces 70 and 72 with the flux guide 42. Precisely curing the adhesive at desired locations assures better bonding of the sheet metal pieces at the desired locations.

There are no substantial risks of creating excessively high current densities at localized areas which could deform the overlapping metal pieces or overheat the adhesive material to the point where it becomes ineffective, when the flux guide 42 is used. Controlling the amount of flux in the flux guide 42 and using the flux guide 42 to conduct the flux uniformly and with uniform density through the gap 44 assures uniform heating, unlike the possibility of irregular flux densities at localized areas created by the corners and angular segments of the prior art single turn coil 12 (FIG. 1). It is not necessary to insert the overlapped metal pieces into the gap to occupy the gap fully to obtain the uniform heating benefits. Only the portion of the overlapped sheets in the gap will be heated uniformly.

There is no possibility of an electrical hazard to personnel who might inadvertently touch the flux guide 42. The flux guide 42 does not conduct electrical current, unlike the prior art single turn coil 12 (FIG. 1) which conducts extremely high current. Consequently, inadvertently touching the flux guide 42 or inserting a finger or part of the human anatomy into the gap 44 will not cause injury.

The flux guide 42 provides inherent electrical isolation from the power supplying components in the flux guide induction heating device 40. The inherent isolation from the flux guide 42 is obtained at no additional cost, compared to the typical coil-type induction heating system 10 which requires the intermediate transformer 38 to provide electrical isolation between the single turn coil 12 and the power supplying components 30, 32 and 34 (FIG. 1).

Because the elongated segments 50 and 52 of the flux guide 42 (FIGS. 2 and 4) are capable of efficiently carrying the flux 68 considerable distances away from the winding 58, the electrical current-carrying and voltage-supporting components 60, 64 and 66 of the device 40 may be located in shielded areas away from the exposed gap 44 and the overlapped metal pieces 70 and 72. In this manner, greater safety is obtained by separating the electrical components away from inadvertent contact by humans.

The ability to shape the segments 46 and 47 of the flux guide at the gap 44, and/or to attach additional magnetic pieces (not shown) to the segments 46 and 47 at the gap 44 offers the ability to direct and apply the flux to overlapped sheet metal pieces in relatively less exposed areas and other hard-to-reach areas that could not be effectively heated by the much larger and more awkwardly shaped prior art single turn coil 12 (FIG. 1). Consequently, heating overlapped metal pieces 70 and 72 with the flux guide 42 offers opportunities to bond metal pieces at locations where bonding was previously impossible or could only be performed with substantial difficulty and expense.

Changing the number of turns of the electrical conductor 60 around the flux guide 42 has the effect of modifying the impedance into which the inverter 66 delivers the drive current 67. Because the drive current 67 is a high frequency signal, matching the impedance of the flux guide 42 with that of the inverter 66 will result in delivering maximum power to the winding 58 according to the frequency of the drive current 67. Different applications may require a change in the frequency of the drive current 67, and/or the use of a different inverter 66. Under such circumstances, the impedance of the flux guide 42 can be changed to accommodate a different frequency or the different inverter by adjusting the number of turns of the conductor 60 which form the winding 58. This is a considerable advantage over coil-type induction heating systems, because to change the impedance in such prior art systems requires that the configuration of the coil be changed. Changing the configuration of the coil requires an extensive amount of labor and cost, as well as unproductive time when the prior art coil-type induction heating system cannot be used.

There is no possibility of melting the metal pieces by inadvertent contact of those pieces with the flux guide 42, unlike the prior art single turn coil 12 (FIG. 1). Inadvertently contacting the metal pieces 70 and 72 at different places on the prior art single turn coil is likely to create a short-circuit condition between those places and through the metal pieces. A very high current will flow through the short-circuiting metal pieces, and may melt or deform the metal pieces along the short-circuit current path. Of course, damaged or melted metal pieces are wasted materials needlessly expended in constructing manufactured products, and compensation for the waste is obtained in the price of the other manufactured products. Electrically insulating the prior art single turn coil may be possible, but the electrical insulation further separates the coil from the metal pieces and thereby diminishes the amount of flux available to interact with the metal pieces.

Because the flux guide 42 delivers substantially all of the flux created by the winding 58 to the overlapping metal pieces 70 and 72, and because multiple turns of the conductor 60 which form the winding 58 are used to create the flux 68, a lesser amount of high frequency drive current 67 is required to create enough flux 68 to adequately heat the metal pieces 70 and 72 and cure the adhesive material 74. The inverter 66 may therefore be of lesser capacity. Furthermore, the inverter 66 may also be more efficient in its energy conversion, because the efficiency of energy conversion is usually related to the magnitude of the high frequency drive current 67 created.

The lesser amount of high frequency drive current 67 makes it easier to control and regulate the drive current 67 supplied to the winding 58. More precise heating effects can be achieved by more precisely controlling the magnitude of the drive current 67. Attempting to control and regulate the bonding temperature with the prior art single turn coil 12 (FIG. 1) is very difficult because the prior art single turn coil can not take advantage of the flux multiplying capabilities obtained by the multiple turns of the winding 58 around the flux guide 42. Consequently, it is easier and more precise to make smaller changes in the high frequency drive current 67 to create greater changes in the flux induced in the metal pieces 70 and 72 than it is to make more massive changes in an already large intermediate current waveform 36 (FIG. 1). More precise temperature regulation is therefore possible.

The inverter 66 is capable of directly driving the winding 58, without using an intermediate transformer 38 (FIG. 1). Eliminating the intermediate transformer eliminates one of the energy conversion steps, and therefore increases the overall system energy efficiency. More of the energy 62 supplied to the flux guide induction heating device 40 is actually transferred into the heat necessary for curing the bond. The overall energy efficiency is increased considerably as a result of using the flux guide 42. Energy usage with the flux guide inductive heating device 40 is expected to be only about 25 percent or less of the amount of energy required to power a typical prior art coil-type induction heating system 10.

Because of the flux multiplying capabilities of the multi-turn winding 58 and the considerably greater efficiency of the flux guide 42 in directing the generated flux into the overlapped metal pieces 70 and 72, it is not necessary to use the larger capacity, more expensive rectifier 32 and inverter 34 which are typically required in the prior art coil-type induction heating system 10 (FIG. 1). Of course, the intermediate transformer 38 is eliminated entirely. Both the acquisition and operating costs of the flux guide induction heating device 40 are substantially reduced, compared to those of a prior art coil-type induction heating system. Moreover, it is not necessary to distribute relatively high voltage three-phase power throughout the manufacturing facility because the considerably lesser current requirements of the flux guide induction heating device 40 can be adequately satisfied from more common lower voltage sources of commercial power.

No separate cooling system 26 (FIG. 1) is required to cool the flux guide 12. The substantial majority of the energy of the drive current 67 flowing through the winding 58 is transformed into heating energy for the metal pieces 70 and 72. Eliminating the cooling system also eliminates acquisition and operating costs.

The reduced capacity and size of the components used in the flux guide induction heating device 40, and the elimination of the cooling system, reduces the amount of floor space required in the manufacturing facility to set up and use the heating device 40. Freeing up more available floor space in the manufacturing facility has the advantage of more effectively utilizing the manufacturing facility for additional productive purposes.

On the whole, it is expected that the use of the flux guide induction heating device 40 described above will result in approximately a 75 percent energy savings compared to the energy required by a coil type induction heating system. The energy savings are in addition to the expected reduction in acquisition costs, the increased efficiency of manufacturing products, the increased availability of space in the manufacturing facility for other productive uses, and the reduction in costs achieved by not distributing separate power supply conductors within the manufacturing facility.

For these and other reasons, the present invention represents a significant advancement in the field of heat curing adhesive material to bond sheet pieces together. Even more improvements and benefits will be apparent upon fully comprehending the significance of the invention.

Presently preferred embodiments of the invention and many of its improvements have been described with a degree of particularity. The specificity of this description is of the preferred examples for implementing the invention. The specificity of description is not necessarily intended to limit the scope of the invention, because the scope of the invention is defined by the following claims.

1. A method of curing a heat-curable adhesive material positioned between overlapping sheets of electrically-conductive material to bond the sheets together, comprising:
directing alternating magnetic flux through a high permeability flux guide to an area of the overlapped sheets between which adhesive material is positioned; and
flowing the flux substantially uniformly through the overlapped sheets at the area for a sufficient time to heat the sheets and cure the adhesive material to bond the sheets together at the area.

2. A method as defined in claim 1, further comprising:
creating the magnetic flux in the flux guide by conducting an alternating drive current through a multi-turn winding positioned around the flux guide.

3. A method as defined in claim 2, further comprising:
using a flux guide having a closed geometric configuration except at a gap which extends across the flux guide; and
inserting the overlapped sheets into the gap to locate the area adjacent to faces of the flux guide which define the gap.

4. A method as defined in claim 3, further comprising:
flowing a substantially uniform density of magnetic flux through the overlapped sheets in the area between the faces.

5. A method as defined in claim 3, further comprising:
spacing the faces apart from one another across the gap at a distance to permit insertion of the overlapped sheets in the gap while minimizing air space between the faces and the overlapped sheets.

6. A method as defined in claim 3, further comprising:
contacting both faces with surfaces of the overlapped sheets in the gap.

7. A method as defined in claim 3, further comprising:
forming one face on a movable segment of the flux guide; and
moving the movable segment to contact its face with one surface of the overlapped sheets in the gap.

8. A method as defined in claim 7, further comprising:
moving the movable segment until both faces contact the surfaces of the overlapped sheets in the gap.

9. A method as defined in claim 8, further comprising:
moving the movable segment to separate the faces after the adhesive material has been cured sufficiently to bond the sheets; and
withdrawing the overlapped bonded sheets from the gap after the faces have been separated.

10. A method as defined in claim 3, further comprising:
extending the geometric configuration of flux guide to separate the winding from the gap sufficiently to avoid contact of the overlapped sheets with the winding upon inserting the overlapped sheets in the gap.

11. A method as defined in claim 1, further comprising:
converting DC power directly into the alternating drive current applied to the multi-turn winding.

12. A method as defined in claim 11, further comprising:
regulating the amount of alternating drive current applied to the multi-turn winding to control the temperature of the overlapped sheets.

13. A method as defined in claim 11, further comprising:
converting commercial AC power into the DC power prior to converting the DC power directly into the alternating drive current; and
electrically isolating the overlapped sheets from the AC power, the DC power and the alternating drive current with the flux guide.

14. A method as defined in claim 11, further comprising:
changing the number of turns of the winding around the flux guide to adjust the impedance into which the drive current is delivered to match an inherent impedance of an inverter used to convert the DC power directly into the alternating drive current.

15. A method as defined in claim 11, further comprising:
changing the number of turns of the winding around the flux guide to adjust the impedance into which the drive current is delivered in accordance differing characteristics of the overlapped sheets and adhesive material at the area within the gap.

16. A method of increasing uniformity in heating a heat-curable adhesive material positioned between overlapping sheets of electrically-conductive material, comprising:
directing an alternating magnetic flux through a flux guide to an area of the overlapped sheets between which adhesive material is positioned;
using a flux guide having a closed geometric configuration except at a gap defined by faces which extend across and through the flux guide;
inserting the overlapped sheets into the gap between the faces; and
flowing the flux substantially uniformly between the faces and through the overlapped sheets adjacent to the faces for a sufficient time to heat the sheets and the adhesive material substantially uniformly over the area of the sheets adjacent to the faces.

17. A method as defined in claim 16, further comprising:
contacting both faces with surfaces of the overlapped sheets in the gap.

18. A method of reducing energy consumption when spot bonding overlapped sheets of electrically-conductive material with heat-curable adhesive material positioned between the overlapped sheets, comprising:
creating alternating magnetic flux in a high permeability flux guide by conducting an alternating drive current through a multi-turn winding positioned around a flux guide having a closed geometric configuration except at a gap defined by faces extending across the flux guide at the gap;
directing substantially all of the magnetic flux created by the drive current conducted through the winding through the flux guide to the gap;
converting commercial AC power into DC power;
converting DC power directly into the alternating drive current conducted through the multi-turn winding; and
flowing substantially all of the flux conducted through the flux guide through the overlapped sheets inserted into the gap for a sufficient time to dissipate energy from the magnetic flux as heat in the sheets and cure the adhesive material to bond the sheets together.

19. A method as defined in claim 18, further comprising:
flowing substantially all of the flux conducted through the flux guide substantially uniformly between the faces and through an area of the overlapped sheets adjacent to the faces to heat the sheets substantially only at the areas adjacent to the faces to a temperature sufficient to cure the adhesive material.

20. A method as defined in claim 19, further comprising:
curing the adhesive material uniformly and substantially only at the areas adjacent to the faces.
